(19) United States
(12) Patent Application Publication
(10) Pub. No.: US 2012/0320853 A1
(43) Pub. Date: Dec. 20, 2012

(54) METHOD FOR TRANSMITTING DATA AND CONTROL INFORMATION IN A WIRELESS COMMUNICATION SYSTEM, A SENDING DEVICE THEREFOR AND A RECEIVING DEVICE THEREFOR

(75) Inventors: Ki Bum Kwon, Ansan-si (KR); Ki Tae Kim, Suwon-si (KR); Sung Jun Yoon, Seoul (KR)

(73) Assignee: PANTECH CO., LTD., Seoul (KR)

(21) Appl. No.: 13/575,286

(22) PCT Filed: Jan. 28, 2011
(86) PCT No.: PCT/KR2011/000626

§ 371 Date: Jul. 25, 2012

(30) Foreign Application Priority Data
Feb. 4, 2010 (KR) 10-2010-0010353

(51) Int. Cl. H04W 72/04

(52) U.S. Cl. 370/329

(57) ABSTRACT

A method and device for sending and receiving control information and data between a terminal and an eNB in a wireless communication system are disclosed, and a method and device for sending and receiving control information and data in accordance with hybrid automatic repeat technology are disclosed. A multiplexer outputs a plurality of hybrid repeat (HARQ) blocks that store data blocks to be transmitted via a plurality of component carrier waves, and outputs multiplexed data obtained by the multiplexing of the data blocks. Repeat data is transmitted by using a component carrier wave that differs from the component carrier wave used during the initial transmission, thereby obtaining gain of diverse channel states for predetermined component carrier waves and frequency bands, and so improving HARQ performance.

### CROSS-REFERENCE TO RELATED APPLICATIONS

This application is the National Stage Entry of International Application No. PCT/KR2011/000626, filed on Jan. 28, 2011 and claims priority from and the benefit of Korean Patent Application No. 10-2010-0010353, filed on Feb. 4, 2010, all of which are hereby incorporated by reference for all purposes as if fully set forth herein.

### BACKGROUND

1. Field

The present disclosure relates to a wireless communication system and, more specifically, to a method and apparatus for transmitting and receiving control information and data according to hybrid automatic repeat technology.

2. Discussion of the Background

A current mobile communication system is getting out of service focused on voice and developing into a high speed and high capacity communication system capable of transmitting and receiving various data, such as video and wireless data.

For this reason, technology capable of transmitting high capacity data comparable to a wired communication network needs to be developed. Furthermore, a proper error detection method capable of minimizing a reduction in the loss of information and improving system performance by increasing system transmission efficiency has been described as an essential element.

In relation to the above, Automatic Repeat request (ARQ) technology or Hybrid ARQ (HARQ) technology are being discussed as the error detection method. The ARQ and Hybrid ARQ schemes are techniques in which a reception apparatus transmits acknowledgement (ACK) to a transmission apparatus if the reception apparatus has received data properly and the reception apparatus transmits not acknowledgement (NACK) indicative of a repeat request to the transmission apparatus if the reception apparatus has not received data properly.

Accordingly, in relation to the error detection method of data, the next-generation wireless communication system requires a more efficient scheme for transmitting and receiving control information and data in order to guarantee reliability of data.

### SUMMARY

An object of the present invention is to provide a method and apparatus for transmitting and receiving control information and data for guaranteeing reliability of data in a wireless communication system.

Furthermore, the present invention provides a method and apparatus for transmitting and receiving control information and data for guaranteeing reliability of data through a specific component carrier in a wireless communication system using a plurality of component carriers.

Furthermore, the present invention provides a data transmission and reception method and apparatus according to hybrid automatic repeat in a wireless communication system using a plurality of component carriers.

Furthermore, the present invention provides a method and apparatus for transmitting and receiving HARQ data through a component carrier indicated by control information in a wireless communication system using a plurality of component carriers.

Furthermore, the present invention provides a method and apparatus for transmitting and receiving data by using one logical HARQ buffer in a wireless communication system using a plurality of component carriers.

Furthermore, the present invention provides a method and apparatus for transmitting and receiving data through HARQ memory regions logically distinguished from one another based on respective component carriers in a wireless communication system using a plurality of component carriers.

In accordance with an aspect of the present invention, there is provided an apparatus for transmitting data in a wireless communication system that supports a plurality of CCs. The data transmission apparatus includes a plurality of Hybrid Automatic Repeat reQuest (HARQ) blocks corresponding to the plurality of CCs in a one-to-one manner and storing a data block to be transmitted through a specific CC, a multiplexer multiplexing the data block and outputting multiplexed data, a scrambler performing scrambling on the multiplexed data and outputting the scrambled data, one or more transmission units transmitting the scrambled data through a predetermined CC, and a scheduler controlling the plurality of HARQ blocks, the multiplexer, and the transmission units by indicating HARQ control information with consideration taken of the initial transmission and retransmission of the data block.

In accordance with another aspect of the present invention, there is provided a method of transmitting data in a wireless communication system supporting a plurality of Component Carriers (CCs). The data transport method includes the steps of storing a data block to be transmitted through a specific CC in a plurality of HARQ blocks corresponding to the plurality of CCs in a one-to-one manner, multiplexing the data block and outputting multiplexed data, performing scrambling on the multiplexed data and outputting the scrambled data, and transmitting one or more transport blocks through which the scrambled data is transmitted through a predetermined CC.

In accordance with yet another aspect of the present invention, there is provided an apparatus for receiving data in a wireless communication system supporting a plurality of Component Carriers (CCs). The data reception apparatus includes a CC check unit checking a specific CC based on information about the CCs, a reception unit receiving scrambled data through the checked specific CC, a demultiplexer demultiplexing the scrambled data and outputting a data block, an HARQ information check unit checking HARQ control information related to the transmission or retransmission of the data block, a data restoration unit storing the data block in an HARQ block corresponding to the checked specific CC, from among a plurality of HARQ blocks corresponding to the plurality of CCs in a one-to-one manner, based on the HARQ control information and demodulating and decoding the data block, an ACK/NACK determination unit generating an ACK/NACK signal according to a result of the demodulation and decoding of the data block, and a transmission unit transmitting the ACK/NACK signal.

In accordance with further yet another aspect of the present invention, there is provided a method of receiving data in a wireless communication system supporting a plurality of Component Carriers (CCs). The data reception method includes the steps of checking a specific CC based on information about the CCs, receiving scrambled data through the checked specific CC, demultiplexing the scrambled data and outputting a data block, checking HARQ control information related to transmission or retransmission of the data block, storing the data block in an HARQ block corresponding to the checked specific CC, from among a plurality of HARQ blocks corresponding to the plurality of CCs in a one-to-one manner, based on the HARQ control information, demodulating and decoding the data block, generating an ACK/NACK signal according to a result of the demodulation and decoding of the data block, and transmitting the ACK/NACK signal.

In the present invention, in a situation in which a reception apparatus gets out of the service range of a relevant CC owing to a change in the position of the reception apparatus, if the transmission of data is failed, if a channel state is not changed over time, or in a specific environment in which CCs have different service ranges, retransmission data is transmitted by using a CC different from a CC on which the data is transmitted. Accordingly, the gain of channel state diversity for a predetermined CC and frequency band can be obtained, and performance for an HARQ can be improved.

### BRIEF DESCRIPTION OF THE DRAWINGS

FIG. 1 is a diagram showing a wireless communication system to which the present invention is applied.

FIG. 2 is a diagram showing mapping between an HARQ process and data in a wireless communication system using a plurality of component carriers to which the present invention is applied.

FIG. 3 is a diagram showing the structure of control information including information related to an HARQ process according to the present invention.

FIG. 4 is a diagram showing mapping between an HARQ process and data according to the present invention.

FIG. 5 is a block diagram of a transmission apparatus according to an embodiment of the present invention.

FIG. 6 is a diagram conceptually showing memory for storing data transmitted by CCs according to the present invention.

FIG. 7a is a block diagram of a transmission apparatus according to another embodiment of the present invention.

FIG. 7b is a block diagram of a transmission apparatus according to yet another embodiment of the present invention.

FIG. 7c is a block diagram of a transmission apparatus according to further yet another embodiment of the present invention.

FIG. 8a is a block diagram of a reception apparatus according to an embodiment of the present invention.

FIG. 8b is a block diagram of a reception apparatus according to another embodiment of the present invention.

FIG. 8c is a block diagram of a reception apparatus according to yet another embodiment of the present invention.

FIG. 9 is a block diagram of a reception apparatus according to further yet another embodiment of the present invention.

FIG. 10 is a flowchart showing an HARQ operation in which CCs are taken into consideration according to the present invention.

FIG. 11 shows a block diagram of a reception apparatus according to an embodiment of the present invention.

### DETAILED DESCRIPTION OF THE ILLUSTRATED EMBODIMENT

Hereinafter, some embodiments of the present invention will be described in detail with reference to exemplary drawings. It is to be noted that in assigning reference numerals to respective elements in each of the drawings, the same reference numerals designate the same elements although the elements are shown in different drawings. Furthermore, in describing the present invention, a detailed description of the known functions and constructions will be omitted if it is deemed to make the gist of the present invention unnecessarily vague.

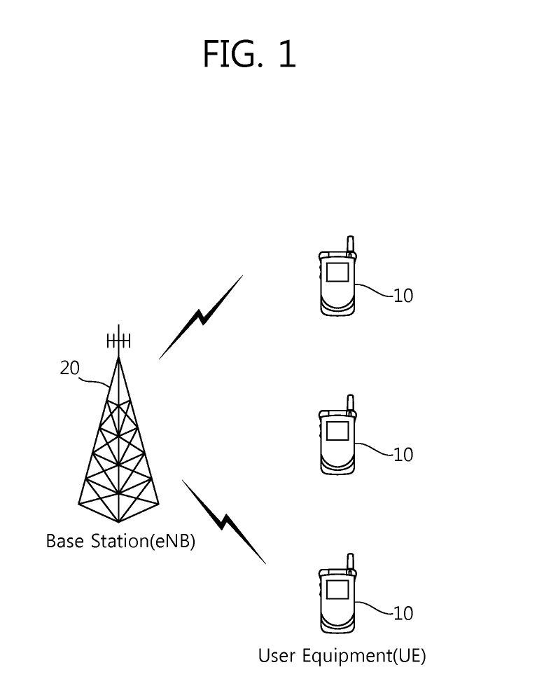

FIG. 1 is a diagram showing a wireless communication system to which the present invention is applied. In the present invention, a wireless communication system is a system for providing various communication services, such as voice and packet data.

Referring to FIG. 1, the wireless communication system includes User Equipment (UE) 10 and an eNB 20 (or Base Station (BS)).

The UE 10 in the present invention is a comprehensive concept meaning a user terminal in wireless communication, and it should be interpreted as a concept including not only UE in WCDMA, LTE, and HSPA, but also a Mobile Station (MS), a User Terminal (UT), a Subscriber Station (SS), and a wireless device in GSM.

In general, the BS 20 or a cell refers to a fixed station which communicates with the UEs 10, and it may also be called another terminology such as node-B (NodeB), an evolved Node-B (eNB), or a Base Transceiver System (BTS), or an access point.

That is, in the present invention, the eNB 20 or cell should be interpreted as a comprehensive meaning that indicates some regions covered by a Base Station (BS) in CDMA and a NodeB in WCDMA, and it covers all various coverage areas, such as mega cell, a macro cell, a microcell, a pico cell, and a femto cell.

The UE 10 and the eNB 20 are two types (uplink or downlink) of transmission and reception entities used to embody technology or technological spirit described in the present invention and are used as comprehensive meanings, but they are not limited by specially designated terms or words. Hereinafter, in this specification, a transmission apparatus and a reception apparatus may be the UE 10 or the eNB 20.

Multiple access schemes applied to the wireless communication system are not limited. A variety of multiple access schemes, such as Code Division Multiple Access (CDMA), Time Division Multiple Access (TDMA), Frequency Division Multiple Access (FDMA), Orthogonal Frequency Division Multiple Access (OFDMA), OFDM-FDMA, OFDM-TDMA, and OFDM-CDMA, may be used.

In uplink transmission and downlink transmission, a Time Division Duplex (TDD) method of performing transmission using different times may be used or a Frequency Division Duplex (FDD) method of performing transmission using different frequencies may be used.

An embodiment of the present invention may be applied to fields, such as asynchronous wireless communication evolving into Long Term Evolution (LTE) and LTE-advanced and synchronous wireless communication evolving into CDMA, CDMA-2000, and UMB through GSM, WCDMA, and HSPA. The present invention should not be interpreted as being limited or restricted to specific wireless communication fields, but should be interpreted as including all technological fields to which the spirit of the present invention may be applied.

The present invention provides a scheme for transmitting and receiving data by using a Hybrid ARQ (hereinafter referred to as ‘HARQ’) method when an error for transmitted data occurs in a method of transmitting control information and data between transmission and reception apparatuses in a wireless communication system using a plurality of component carriers.

First, the HARQ method is technology in which the channel coding of a physical layer is combined with the existing ARQ method. Unlike in the existing ARQ method in which when a reception apparatus fails to receive data, the reception apparatus discards the data and informs a transmission apparatus of the failure or if a specific time or more elapses, the reception apparatus retransmits data stored in the transmission apparatus simply, in the HARQ method, all or only some of stored data is transmitted when the data is initially transmitted. When a reception apparatus fails to receive the data, the reception apparatus stores the data, whereas a transmission apparatus retransmits all or some of the stored data. Next, the reception apparatus combines the retransmission data with the previously stored data, thereby increasing a reception performance gain.

Meanwhile, in wireless communication systems being recently discussed, for example, LTE-Advanced (LTE-A), a concept for the use of a plurality of component carriers is being introduced.

This concept is a scheme for expanding a bandwidth in order to satisfy a high data transfer rate required in LTE-A. In this concept, a unit carrier is defined as a Component Carrier (referred to as a CC). Here, each CC may have a bandwidth having a maximum of 20 MHz, and a Carrier Aggregation (hereinafter referred to as a ‘CA’), that is, a concept that a plurality of CCs is bundled into one system, may be taken into consideration.

Accordingly, a concept that expands a bandwidth up to a maximum of 100 MHz is defined. Here, frequency bands that may be determined, that is, allocated by CCs, may be contiguous or non-contiguous depending on the scheduling of an actual CA.

The present invention includes that in transmitting data in a CA wireless communication environment, a transmission apparatus using the HARQ method selects a specific CC suitable for the retransmission of data from CCs available to a reception apparatus according to a predetermined rule or the existing measurement values and retransmits the data through the selected CC.

In a wireless communication system according to the present invention, HARQ can actively use a variety of channel states according to additional information transmission and time for information data in order to recover an error when an error is generated in transmission.

Hereinafter, in the present invention, a mapping relationship between an HARQ process and wireless resources for data is described, and a transmission apparatus and a reception apparatus for embodying the mapping relationship are sequentially described.

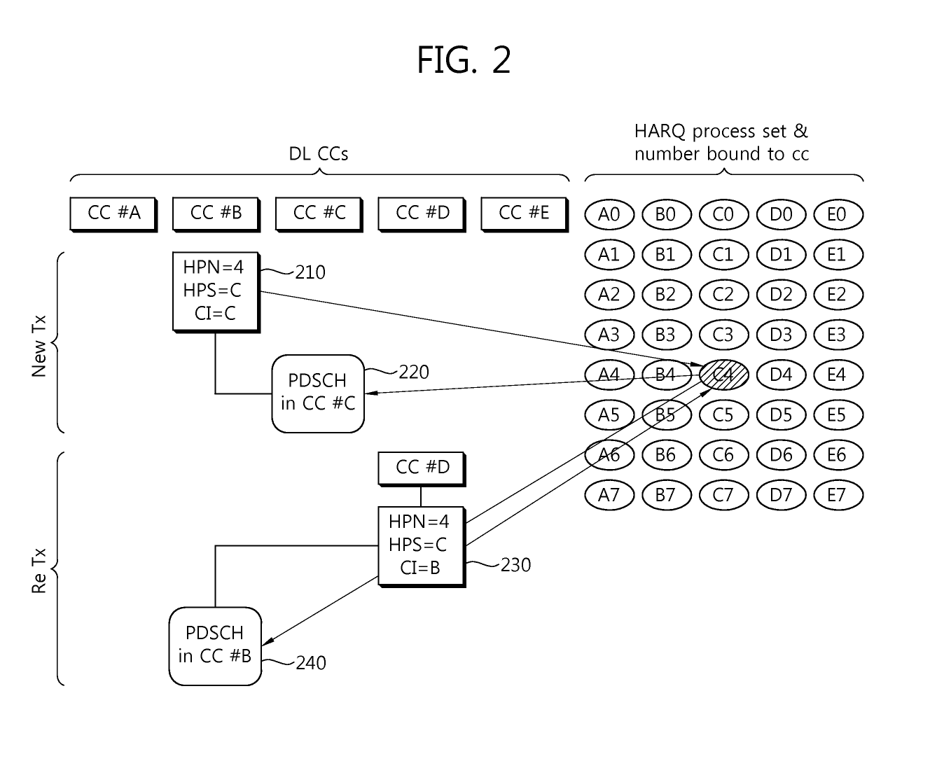

FIG. 2 is a diagram showing mapping between an HARQ process and data in a wireless communication system using a plurality of CCs to which the present invention is applied.

Referring to FIG. 2, in the wireless communication system using the plurality of CCs, the number of CCs allocated to specific UE 10 is n (e.g., n=5). The frequency bands of the respective CCs may be contiguous to each other or may be spaced apart from each other in a specific frequency band.

Here, each of the CCs may manage a plurality of HARQ processes in relation to an HARQ operation. Furthermore, the HARQ processes may be grouped into n sets. Here, each of the n sets may have a specific number of process entities, for example, 8 process entities (C0 to C7 in case of a CC #C).

Meanwhile, each of the CCs may include or not include control channel in relation to downlink/uplink transmission. Here, in a specific CC, the control channel may indicate the existence of a data channel on a specific CC or indicate the existence of the data channel on another CC.

In relation to the above, the present invention includes supporting cross-carrier scheduling. As the cross-carrier scheduling is supported, first control information 210 about a first CC can be transmitted through another second CC.

For example, the first control information 210 about a CC #C, that is, a first CC, may be transmitted through a CC #B, that is, a second CC. Meanwhile, data 220 received from a higher layer may be transmitted to UE through a CC #C, and control information relate to the data 220 may be transmitted through a CC #B.

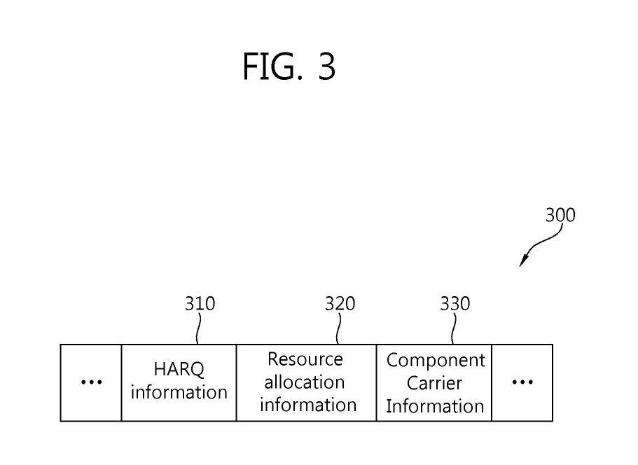

In other words, a scheduler may transmit the first control information 210 to UE through the control channel (PDCCH) of the CC #B and the data 220 to the UE through the data channel (PDSCH) of the CC #C, in relation to the data received from a higher layer. Here, the first control information 210 transmitted through the CC #C may include information related to an HARQ process. The information related to an HARQ process will be described in more detail below with reference to FIG. 3 below.

FIG. 3 is a diagram showing the structure of control information including information related to an HARQ process according to the present invention.

Referring to FIG. 3, control information 300 about a CC that stores information related to an HARQ process includes HARQ information 310, resource allocation information 320, and CC information 330.

The HARQ information 310 includes an HARQ Process Set (hereinafter referred to as an HPS), an HARQ Process Number (hereinafter referred to as an HPN), and a Redundancy Version (hereinafter referred to as an RV).

Here, the HPS includes information about a set including at least one HARQ process that performs an HARQ. That is, the HPS may include information about an HARQ set that is determined by a plurality of CCs that perform an HARQ operation related to data. For example, when the number of CCs that may be assigned to specific UE at the same time is n, an HARQ process may be grouped into n HPSs. That is, the n HPSs are mapped to downlink/uplink CCs. That is, when the n HPSs mapped to respective downlink/uplink CCs are indicated, it can be seen that an HARQ operation for transmission/retransmission according to data transmission is performed in a CC #C from FIG. 2 because the HPS is set to the C (i.e., HPS=C).

Meanwhile, the HPN indicates an HARQ process entity that is responsible for an HARQ. In other words, the HPN is information that indicates an HARQ process involved in the actual retransmission of data, from among all HARQ processes for respective CCs. Furthermore, the RV may include RV information related to the decoding of data.

For example, in FIG. 2 when a new packet is transmitted (New Tx), control information, an HPN=4, and an HPS=C, and CI=C are set and transmitted through the CC #B. Accordingly, it can be seen that UE receives data through the CC #C and an HARQ operation is performed through an HARQ process entity, that is, the fourth of a process set C in relation to the received data.

Meanwhile, the resource allocation information 320 means information about frequency resources allocated to specific time, from among a plurality of resource blocks that may be used by a scheduler. That is, the resource allocation information 320 includes information about resources allocated on the predetermined time when UE may use the resources. The resource allocation information 320 may mean information about a frequency band available in a relevant CC.

Finally, the CC information 330 includes information that directly indicates a Carrier Indicator (CI) regarding that data is actually transmitted and retransmitted. Alternatively, the CC information 330 may include first ID information about a CC that indicates the use of another carrier when cross-carrier scheduling is used.

An expression for a CI may be allocated in various ways depending on a number of a CC and used. If the number of CCs is limited to 5, the CI may have a value of 0-4 or 1-5.

Accordingly, when CI=C, UE can know that a CC on which data is transmitted is CC #C. It can be seen that an HARQ operation is performed through a fourth HARQ process entity regarding the CC #C because the HPS=C.

If NACK is received from a reception apparatus or if ACK is not reached for a specific time, a wireless communication system retransmits data stored in a data buffer according to an HARQ algorithm.

Here, if a specific CC for previously transmitted data is allocated for the transmission of data by another UE, the present invention supports the cross-carrier scheduling of CCs for the transmission and retransmission of new data.

Referring back to FIG. 2, retransmission data 240 may be transmitted through a CC #B 240 different from the previously transmitted CC #C 220. Thus, second control information 230 indicating the CC #B on which the retransmission data 240 is retransmitted may be transmitted to UE through the control channel (PDCCH) of another CC #D.

Here, the second control information 230 about the CC #B includes pieces of HARQ-related information described with reference to FIG. 3. In the second control information 230, an HPN and an HPS, that is, pieces of HARQ-related information, include the same information as the HPN and the HPS of the first control information 210. The HPN and the HPS designate the CC information 330, that is, a CI that is the second ID information of a CC indicating the CC #B on which the data 240 is retransmitted (CI=B).

In summary, first ID information to identify the first CC #C on which new data is transmitted and second ID information to identify the second CC #B on which retransmission data is transmitted can be differently set and transmitted.

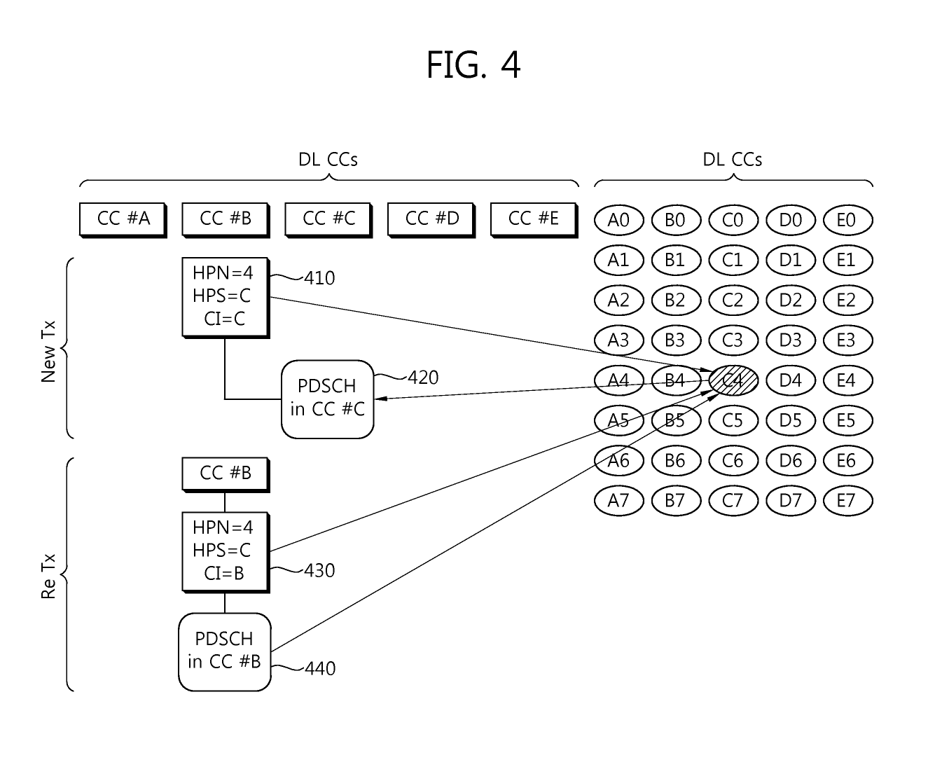

FIG. 4 is a diagram showing a mapping relationship between an HARQ process and data according to the present invention.

Referring to FIG. 4, the case where a CC on which first control information 410 is transmitted and a CC on which second control information 430 is transmitted have the same state, that is, CC #B is described.

Information related to an HARQ process, indicated by the first control information 410, includes CC. It indicates that data is transmitted through a CC #C and an HARQ process is specified by an HPN=4 and an HPS=C.

Meanwhile, information related to the HARQ process, indicated by the second control information 430, includes a CI=B. It indicates that data is retransmitted through the CC #B and the HARQ process for the retransmission data is the same as the HARQ process according to the first control information 410.

Accordingly, the data transmitted through the CC #C is retransmitted through the CC #B. Here, the retransmission data performs an HARQ operation by using the HPN=4 and the HPS=C based on the second control information 430. That is, an HARQ for the retransmission data is performed through the HARQ process entity 4 of the CC #C.

As described already, CI=C and CI=B may be set so that the first CC CC #C on which data is primarily transmitted and the second CC CC #B on which data is retransmitted when the data is retransmitted are different from each other.

In other words, the first CC on which data is primarily transmitted and the second CC on which data is retransmitted when the data is retransmitted are different from each other. CCs including pieces of control information that designate the first CC and the second CC, respectively, may be the same or different from each other.

Accordingly, in the present invention, CCs can be adaptively used with flexibility by taking a CC environment into consideration at a point of time at which control information and data are transmitted. Furthermore, if data including information is transmitted through a CC having marginal wireless resources when the transmission of control information and data is difficult to be focused on a specific CC, consecutive data transmission can be supported and received data performance can be guaranteed. Furthermore, reliability of received data can be guaranteed by using different CCs in order to guarantee an HARQ for retransmission.

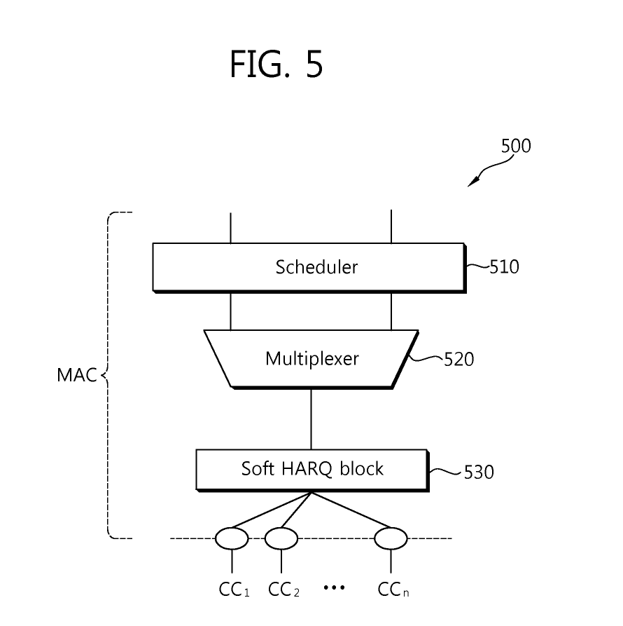

FIG. 5 is a block diagram of a transmission apparatus according to an embodiment of the present invention.

Referring to FIG. 5, the transmission apparatus 500 includes a scheduler 510, a multiplexer 520, and a soft HARQ block 530.

The scheduler 510 allocates data, received from a higher layer, to specific time-frequency wireless resources, that is, a specific CC suitable for the transmission of the data. Here, the scheduler 510 schedules the allocation of the CC for the new transmission and retransmission of the data by taking the overall communication environment of CCs, managed by the scheduler 510, into consideration.

For example, the scheduler 510 may allocate CC resources by taking the total number of UEs within a CC or a frequency band available to a CC into consideration so that the new transmission and retransmission of data are performed through different CCs.

For example, the scheduler 510 may perform control so that new transmission (New Tx) is performed through a CC3 and retransmission (Re Tx) is performed through a CC2. Furthermore, the scheduler 510 may perform control so that control information for new transmission and retransmission is transmitted through different CCs or the same CC.

Meanwhile, the scheduler 510 allocates a CC so that retransmission data according to an HARQ algorithm is transmitted through a CC different from a previous transmitted CC when at least one of conditions i) that the number of retransmissions exceeds a maximum number of retransmissions, ii) that link performance indices, such as reception power, interference power, and an SINR are a threshold or lower, iii) that the position of UE gets out of the service range of data through a CC, iv) that the amount of an available CC is a threshold or lower, and v) that a specific CC must be changed according to the requirements of a network system is satisfied or when a combination of the conditions is satisfied.

Here, the scheduler 510 controls the allocation of data to a CC by taking the link setup environment and service quality of the CC into consideration and also controls the operation of the multiplexer 520 in relation to data allocated to each CC.

The multiplexer 520 multiplexes data received from a higher layer and transfers the multiplexed data to the soft HARQ block 530. That is, the multiplexer 520 is a block that allocates data, received from a higher layer, to the memory regions of the soft HARQ block 530 corresponding to respective CCs under the control of the scheduler 510.

The soft HARQ block 530 receives data from the multiplexer 520 and stores the received data in an HARQ data buffer. The soft HARQ block 530 receives ACK/NACK from UE, generates HARQ-related information based on the ACK/NACK, and outputs a redundancy version for new data or retransmission data by taking the ACK/NACK into consideration.

Here, the soft HARQ block 530 may generate pieces of HARQ-related information including first control information and second control information that have the same HPN and HPS, but have different CIs. The pieces of HARQ-related information may be generated by taking the use of the use of a relevant CC of the scheduler 510 into consideration. In other words, the first control information and the second control information may additionally include respective pieces of HARQ-related information having the same HPN and HPS. Furthermore, if the same HPN and HPS are allocated to different CCs, they have different CI values. Accordingly, it means that first control information and second control information different from each other can be generated using the CI value.

Furthermore, the soft HARQ block 530 stores data, transmitted by CCs CC1 to CCn, in memory regions allocated for the respective CCs based on the HARQ-related information.

For example, when data x is transmitted on a first CC, the soft HARQ block 530 stores the data x in a memory region allocated for the first CC. Furthermore, when the data x is retransmitted, the soft HARQ block 530 performs control so that the data x stored in the memory region allocated for the first CC is transmitted through a second CC.

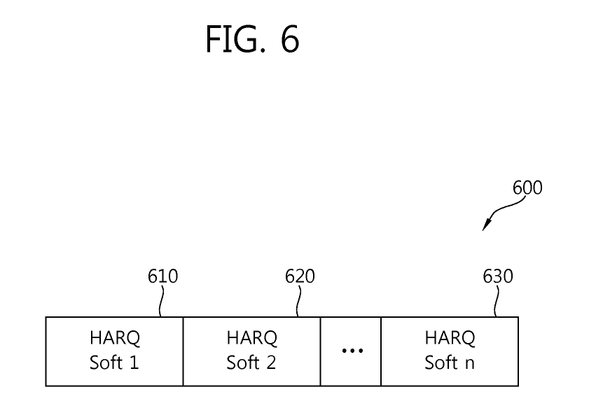

FIG. 6 is a diagram conceptually showing memory for storing data transmitted by CCs according to the present invention.

Referring to FIG. 6, the soft HARQ block 530 uses memory or data buffer regions 610 to 630 for storing data transmitted on CCs by using memory addresses which are physically identical with each other, but are logically distinguished from one another. Alternatively, the soft HARQ block 530 may use the data buffer regions which are physically distinguished from one another for respective CCs. Thus, data primarily transmitted on a first CC can be retransmitted through a second CC.

In other words, in the present invention, the data buffer regions 610 to 630 corresponding to the respective CCs have logical addresses within the one memory 600, and they are distinguished from one another for a predetermined time. Here, the predetermined time refers to the time taken to transmit data based on specific service. During the time, a different period can be set based on the specific service. Here, the time may be variably set by taking the data rate and reception performance of the service into consideration.

The present invention can support the transmission and retransmission of service data through a plurality of CCs by using one memory including buffer regions which are logically distinguished from one another during time determined based on the support of specific service. Furthermore, as another method, a plurality of memories which are physically distinguished from one another for each CC in relation to specific service data may be used to support the initial transmission and retransmission of the data.

Accordingly, wireless resources for data transferred by a higher layer are allocated by the scheduler 510. That is, when data to be transmitted to a first CC is transferred through the multiplexer 520, the data is stored in a buffer region allocated for the first CC within the soft HARQ block 530. Here, the soft HARQ block 530 temporarily stores the data for a predetermined time for HARQ retransmission.

If the transmission apparatus 500 receives NACK for data from a reception apparatus after transmitting the data through a first CC, the scheduler 510 allocates a second CC on which the data will be retransmitted. Here, the soft HARQ block 530 includes an HPN and HPS, having the same HPN and HPS included in first control information, in second control information as the HARQ-related information 310 indicating the retransmission of the data transmitted through the first CC and sets a value in which 1 is added to a value of the redundancy version of the data as the redundancy version of the retransmission data.

Furthermore, the soft HARQ block 530 includes the CC allocation information 330, indicating the second CC different from the first CC for the retransmission, in control information and sends the control information to the reception apparatus, so that reliability and the use of adaptive CCs according to data transmission are guaranteed for the reception apparatus.

The soft HARQ block 530 transfers the retransmission data to the second CC so that the data primarily transmitted by the first CC is retransmitted through the second CC based on the CC allocation of the scheduler 510 and the generation of the pieces of HARQ-related information 310 and 330.

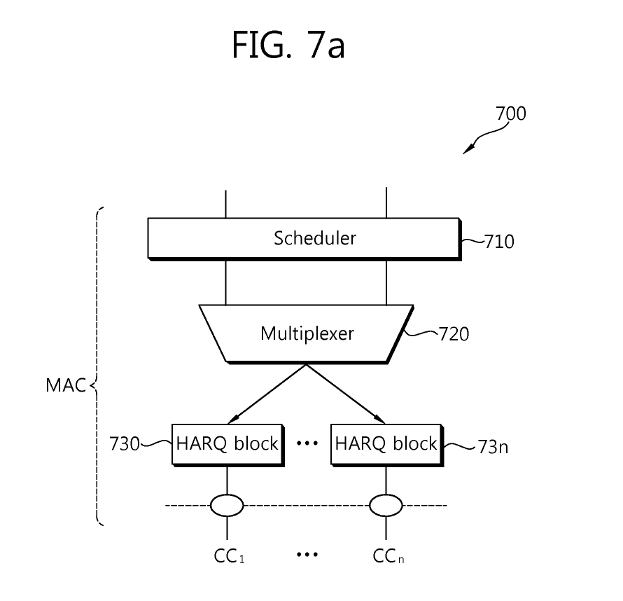

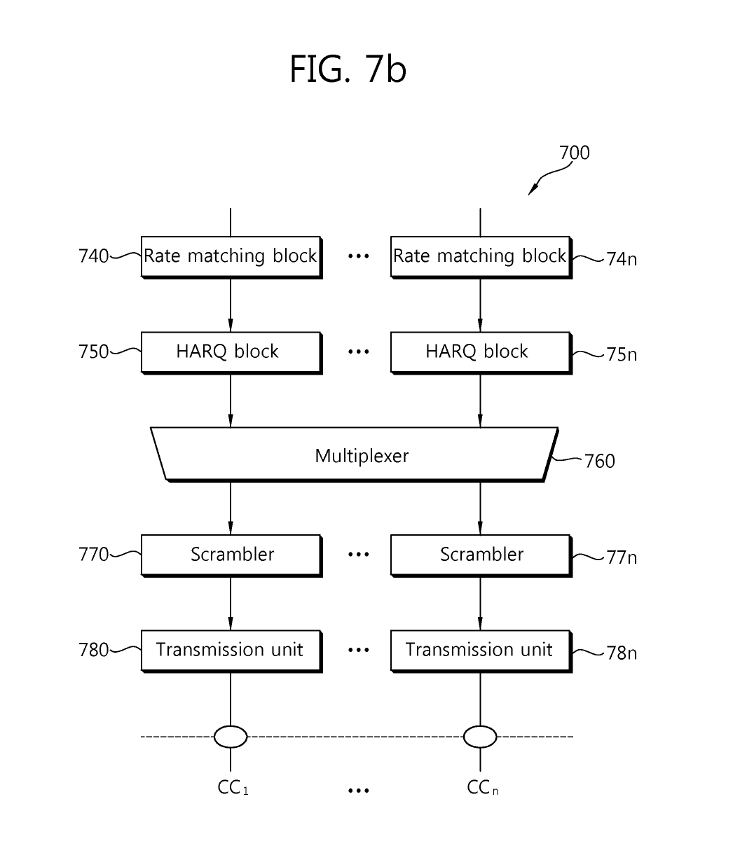

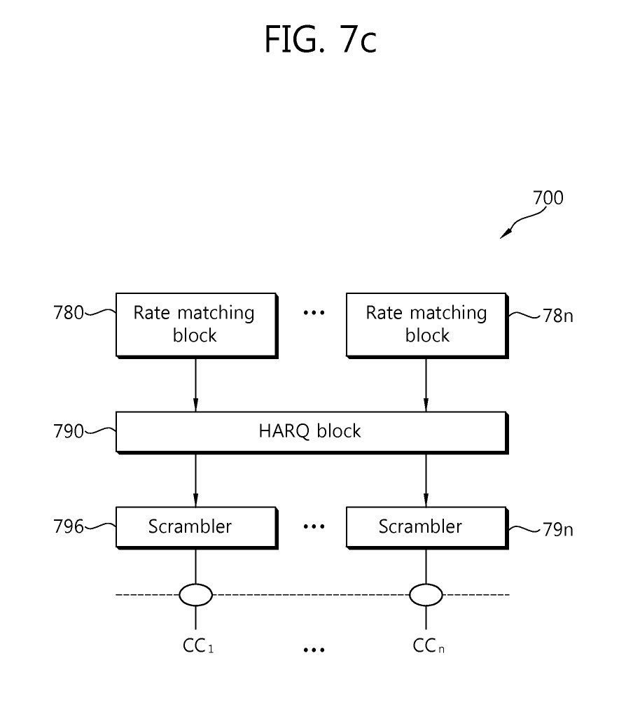

FIG. 7a is a block diagram of a transmission apparatus according to another embodiment of the present invention.

Referring to FIG. 7a, the transmission apparatus 700 includes a scheduler 710, a multiplexer 720, and a plurality of HARQ blocks 730 to 73n. Here, the scheduler 710 and the multiplexer 720 are the same as those of FIG. 5 and a detailed description thereof is partially omitted.

If the transmission apparatus 700 receives NACK for data from a reception apparatus after transmitting the data on a first CC, the scheduler 710 allocates a second CC for retransmitting the data. Here, the scheduler 710 controls the operations of the plurality of HARQ blocks 730 to 73n so that the plurality of HARQ blocks 730 to 73n corresponds to a plurality of CCs CC1 to CCn in a one-to-one manner.

Furthermore, the scheduler 710 receives data from a higher layer, multiplexes the data for a specific reception apparatus, and controls the operation of the multiplexer 720 so that the multiplexer 720 transfers the data to the HARQ blocks 730 to 73n corresponding to the respective allocated CCs.

The plurality of HARQ blocks 730 to 73n controls new transmission and retransmission through the respective CCs based on the allocation of the CCs according to control of the scheduler 710 and the generation of the pieces of HARQ-related information 310 and 330.

For example, the plurality of HARQ blocks 730 to 73n performs control so that data is primarily transmitted through a first CC and the data is retransmitted through a second CC. Next, each of the HARQ blocks 730 to 73n performs control so that ACK or NACK transmitted by a reception apparatus is received through each of respective CCs.

In other words, the HARQ blocks 730 to 73n receive data to be transmitted from the multiplexer 720 through relevant CCs and store the received data in an HARQ data buffer. Here, the HARQ blocks 730 to 73n receive ACK/NACK from a reception apparatus through the relevant CCs, generates pieces of HARQ-related information, and outputs a redundancy version by taking new data or retransmission data into consideration.

That is, the HARQ blocks 730 to 73n store the data in predetermined memory regions based on the respective CCs CC1 to CCn and performs retransmission on the data for each CC by taking the ACK/NACK into consideration.

FIG. 7b is a block diagram of a transmission apparatus according to yet another embodiment of the present invention.

Referring to FIG. 7b, the transmission apparatus 700 includes a rate matching block 740, an HARQ block 750, a multiplexer 760, and a scrambler 770.

The rate matching block (one of 740 to 74n) receives data to be transmitted through a relevant CC (one of CC1 to CCn). The rate matching block (one of 740 to 74n) performs rate matching on the data to b transmitted through a relevant CC (one of CC1 to CCn) at a predetermined rate.

The HARQ block (one of 750 to 75n) corresponds to a plurality of CCs in a one-to-one manner. An HARQ block (one of 750 to 75n) previously stores data for each CC (one of CC1 to CCn) in preparation for a retransmission request of a reception apparatus at the time of first transmission. For example, the HARQ block 750 stores data to be retransmitted through the CC1, and the HARQ block 751 stores data to be retransmitted through the CC2. Here, the stored data may be a Medium Access Control Protocol Data Unit (MAC PDU).

According to the present invention, the size of the HARQ block (one of HARQ blocks 750 to 75n) is set to a minimum unit obtained by dividing all memory buffers, having one predetermined size, by the number of CCs that can be monitored by a reception apparatus. Furthermore, the size of the HARQ block may be differently set depending on the HPS of each CC and the total number of processes for each set.

Accordingly, the HARQ block (one of 750 to 75n) corresponding to a relevant CC stores received data on which the rate matching has been completed. In the present invention, an HARQ block may have a size equal to a multiple of an integer of the number of processes corresponding to each CC, after the total size of the HARQ memory buffer is divided by a value of the total number of CCs that may be used by a reception apparatus. The HARQ block (one of 750 to 75n) is constructed to correspond to each CC, and it supports the initial transmission and retransmission of relevant data and guarantees reliability and the use of adaptive CCs. For example, if a first HARQ block has initially transmitted a data block through a first CC, but receives NACK for the data block, a second HARQ block retransmits the data block through a second CC.

The multiplexer 760 does not perform a special operation, such as the bypass of data received from the HARQ block (one of 750 to 75n), at the time of initial transmission. Meanwhile, at the time of transmission according to an HARQ operation, the multiplexer 760 multiplexes the data of a CC to be transmitted with consideration taken of pieces of HARQ-related information, such as information about a CI and the number of HARQ process entity, within control information related to data received from the HARQ block (one of 750 to 75n) and outputs the multiplexed data to the scrambler (one of 770 to 77n) of the relevant CC. The pieces of HARQ-related information may include at least one of information about an HPS set with consideration taken of the number of CCs available to a reception apparatus, an HPN used for the initial transmission and retransmission of the data blocks, an RV related to the decoding of the data blocks, and information about a CI used for the initial transmission and retransmission of the data blocks.

For example, when specific data is initially transmitted, the multiplexer 760 connects data outputted from a first HARQ block so that the data is transmitted through a first CC. If the specific data is retransmitted, the multiplexer 760 checks pieces of HARQ-related information and outputs the specific data so that the specific data is retransmitted through a second CC different from the first CC. Here, the multiplexer 760 outputs data, outputted from the HARQ block (one of 750 to 75n), to the scrambler (one of 770 to 77n) of a CC so that the CC can be adaptively used with flexibility at a point of time at which the data, that is, control information and data information, are transmitted by taking a CC environment into consideration. Accordingly, although retransmission is performed by using a different CC, reliability of received data can be guaranteed because an HARQ is guaranteed. Here, although not shown, the multiplexer checks pieces of HARQ-related information indicated by the scheduler 710 and performs the operation of the multiplexer 720.

The scrambler (one of 770 to 77n) performs scrambling on multiplexed data transferred from the multiplexer 760, outputs scrambled data, and outputs the outputted data to the transmission units 780 to 78n.

The transmission unit (one of 780 to 78n) of the transmission apparatus 700 generates a transport block to be transmitted through a physical channel and a Radio Frequency (RF) band by processing scrambled data and transmits the generated transport block through a predetermined CC.

If a plurality of HARQ blocks corresponding to a plurality of CCs in a one-to-one manner is used as described above, ambiguity regarding data to be retransmitted is reduced and a retransmission procedure becomes clear as compared with the case where one HARQ block is used.

FIG. 7c is a block diagram of a transmission apparatus according to further yet another embodiment of the present invention.

Referring to FIG. 7c, the transmission apparatus 700 includes rate matching blocks 780 to 78n, an HARQ block 790, and scramblers 796 to 79n in a physical layer.

The rate matching block (one of 780 to 78n) receives data to be transmitted through a relevant CC (one of CC1 to CCn). The rate matching block (one of 780 to 78n) performs rate matching on the data to be transmitted for relevant CCs CC1 to CCn at a predetermined rate.

The HARQ block 790 stores the data subjected to rate matching for each CC CC1 to CCn in preparation for a retransmission request of a receiver. Here, the HARQ block 790 has memory regions which are logically distinguished from one another based on respective CCs, checks pieces of control information related to the data, such as an HPN, an HPS, and a CI transmitted through a PDCCH, and stores the data in the memory regions of the respective CCs.

The HARQ block 790 performs a bypass operation on initially transmitted data. Meanwhile, the HARQ block 790 performs an operation so that the data of relevant CCs is read out from the memory regions which are logically distinguished from one another and allocated based on the respective CCs in relation to retransmission data. That is, at the time of retransmission, the HARQ block 790 may perform an operation so that data is transmitted from the memory region of a relevant CC based on the HARQ process value (HPS) of the relevant CC.

The scrambler (one of 796 to 79n) performs scrambling on data outputted from the HARQ block 790. The scrambled data is transmitted to a receiver through the physical channel of a relevant CC.

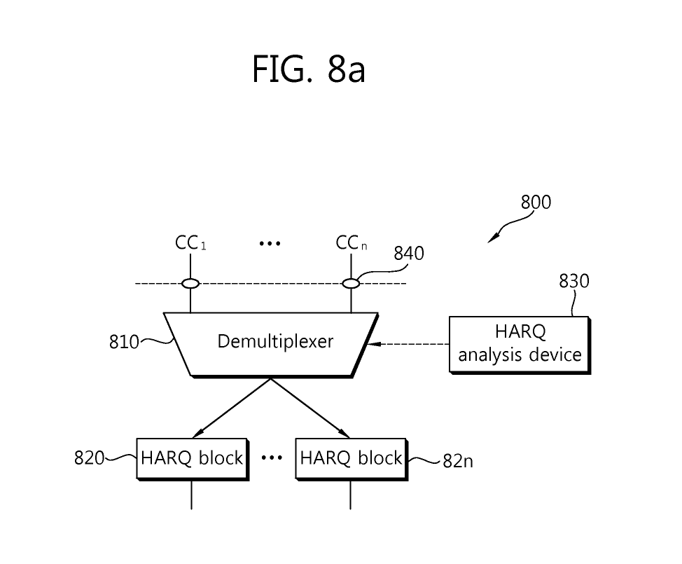

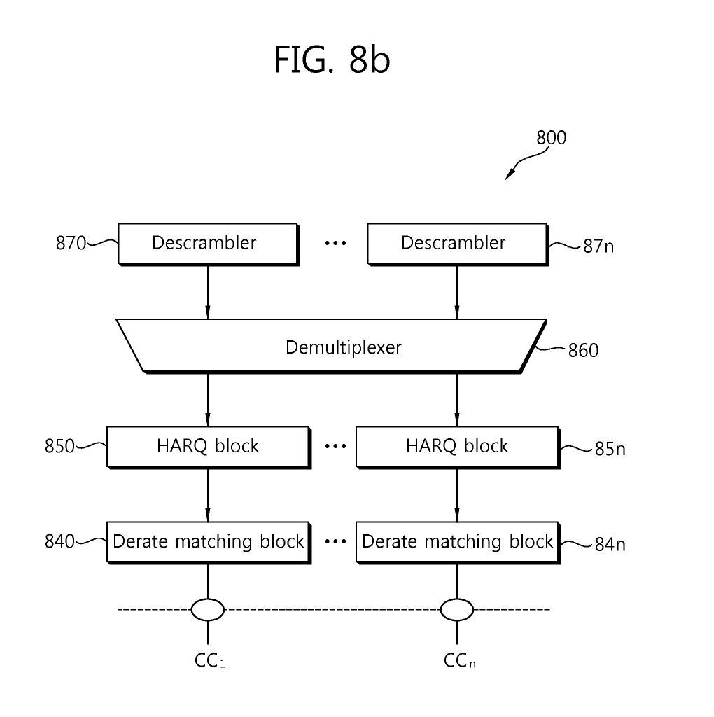

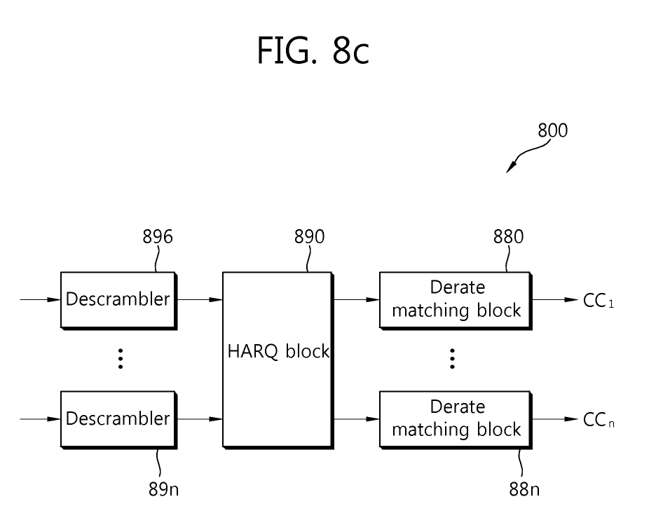

FIG. 8a is a block diagram of a reception apparatus according to an embodiment of the present invention.

Referring to FIG. 8a, the reception apparatus 800 includes a demultiplexer 810, a plurality of HARQ blocks 820 to 82n, and an HARQ analysis device 830.

First, the reception apparatus 800 has to determine whether received data is initially transmitted data or data retransmitted because an error was generated in previously transmitted data. Here, information about the new data or the retransmission data is included in control information about the transmitted data and then transmitted.

If the received data is new data, that is, initially transmitted data, data received through a relevant CC is demodulated through a reception algorithm on the basis of control information about the received data and then stored in a relevant HARQ block. Here, data received for each CC is transferred to the demultiplexer 810. The HARQ analysis device 830 checks whether an error for the initial transmission and retransmission data has been detected or not by using pieces of HARQ-related information.

If an error is not detected in the received data, the reception apparatus 800 transfers the detected data to a higher layer and resets an HARQ memory buffer in which the relevant data is stored. If an error is not detected, however, the reception apparatus 800 stores the data having the error in the HARQ block of a relevant CC.

That is, the HARQ analysis device 830 performs control so that the received data having the error is stored in the HARQ blocks 820 to 82n based on information related to an HARQ process for each CC. Here, the HARQ analysis device 830 performs control so that an HARQ operation is performed through the HARQ block 820 or 82n distinguished from one another based on the respective CCs. The demultiplexer 810 multiplexes data transferred from the HARQ blocks 820 to 82n set based on respective CCs and outputs the multiplexed data.

Meanwhile, if the received data is retransmission data, received through each CC is demodulated by using a reception algorithm through which transmission data can be easily received based on control information about the relevant data, temporarily stored in the HARQ block of the relevant CC, and then demodulated using a predetermined HARQ scheme along with previously transmitted data.

If the original information data can be extracted because a HARQ method used in a wireless communication system allows for recurrent decoding and thus an error is not generated in the data, the data is immediately transferred to a higher layer. If the original information data cannot be extracted or an error has occurred in the data, the following process is performed.

The received data is inputted to the demultiplexer 810 through a relevant CC. The HARQ analysis device 830 sends the received data to relevant HARQ blocks 820 or 82n on the basis of information related to an HARQ process for each CC.

Each of the HARQ blocks 820 to 82n attempts to decode the data according to a predetermined HARQ algorithm by using previously transmitted data and the retransmission data. The HARQ algorithm may be a chase combining method or may be other methods. Here, the chase combining method is a method of increasing an error correction probability by combining previously received error data and currently received data.

If it is checked that an error has not been generated in the received data after the data is decoded according to the HARQ algorithm, each of the HARQ blocks 820 to 82n transfers the relevant data to a higher layer and resets memory related to the data.

If it is checked that an error has been generated in the received data after the data is decoded, each of the HARQ blocks 820 to 82n informs ACK/NACK determination units within the HARQ blocks 820 to 82n of the occurrence of the error and notifies the transmission apparatus so that the data is retransmitted. Here, the above-described reception process is repeatedly performed on the retransmission data.

FIG. 8b is a block diagram of a reception apparatus according to another embodiment of the present invention.

Referring to FIG. 8b, the reception apparatus includes descramblers 870 to 87n corresponding to respective CCs, a demultiplexer 860, a plurality of HARQ blocks 850 to 85n, and derate matching blocks 840 to 84n.

The descrambler 870 performs descrambling on data received through relevant CCs.

The demultiplexer 860 functions to transfer the received data to the relevant HARQ block (one of 850 to 85n) with consideration taken of HARQ-related information, for example, information about a CI or the number of an HARQ process entity, within control information received through a control channel. Furthermore, in case of retransmission data, the demultiplexer 860 functions to transfer the retransmission data to the HARQ block (one of 850 to 85n) in which initially transmitted data is stored by taking the information about a CI or the number of the HARQ process entity into consideration.

The HARQ block (one of 850 to 85n) stores the data transferred from the demultiplexer 860. In case of retransmission data, the HARQ block (one of 850 to 85n) stores the retransmission data in a region where previously transmitted data is stored. In case of initially transmitted data, the HARQ block (one of 850 to 85n) stores received data for a subsequent HARQ operation. Furthermore, the HARQ blocks 850 to 85n read relevant data according to an HARQ operation and perform an operation of detecting an error in the relevant data.

Here, the size of the HARQ block (one of 850 to 85n) is set to a minimum unit obtained by dividing the entire memory buffer having a predetermined size by using an HPS and the total number of processes for each set. Furthermore, in the present invention, each HARQ block may have a size equal to a multiple of an integer of the number of processes that is set based on each CC, after the total size of the HARQ memory buffer is divided by a value of the total number of CCs that may be used by UE.

The HARQ block (one of 850 to 85n) performs an HARQ operation on received data and transfers data without an error to the derate matching block (one of 840 to 84n) corresponding to a relevant CC.

The derate matching block (one of 840 to 84n) performs rate matching on one received datum from among relevant CCs CC1 to CCn without an error. Here, the rate matching includes zero (0) padding based on the size of data of a higher layer, the puncturing of a specific bit, or an operation of forming one service data unit datum by combining two or more packet data unit data.

FIG. 8c is a block diagram of a reception apparatus according to yet another embodiment of the present invention.

Referring to FIG. 8c, the reception apparatus 800 includes descramblers 896 to 89n corresponding to respective CCs, an HARQ block 890, and derate matching blocks 880 to 88n.

The descramblers 896 to 89n perform descrambling on data received through relevant CCs.

The HARQ block 890 stores the received data in memory regions corresponding to relevant CCs within the HARQ block 890 by using HARQ-related information, that is, HARQ-related information about the relevant CCs from among CCs CC1 to CCn, within control information received through a control channel. That is, the HARQ block 890 checks an HPN, an HPS, and a CI received through a PDCCH and stores the descrambled data in the memory regions allocated to the respective CCs CC1 to CCn.

Here, the size of the memory region for each CC may be determined by taking the maximum number of CCs that may be used (monitored) by a receiver (UE) and the number of HARQ sets of a relevant CC into consideration. That is, the size of one HARQ memory buffer ma be divided and used by taking the maximum number of CCs and the number of HARQ sets of a relevant CC into consideration. The HARQ block 890 performs an HARQ operation on the transferred data and transfers data without an error to the derate matching block (one of 880 to 88n) corresponding to the relevant CC.

The derate matching blocks 880 to 88n perform rate matching on the data of the relevant CC based on the size of the data of a higher layer.

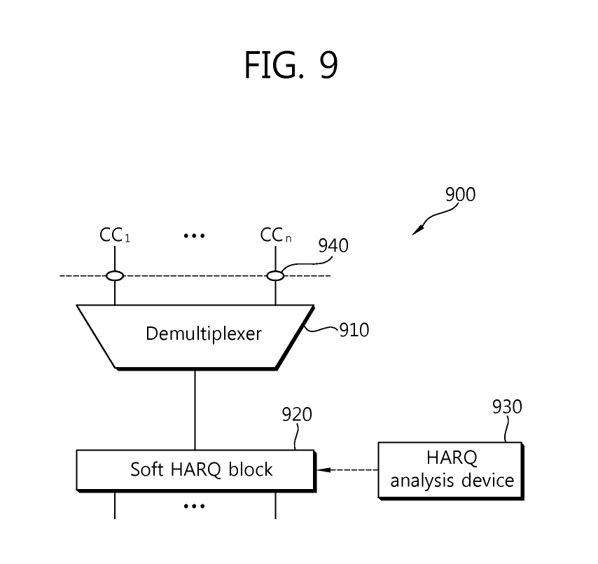

FIG. 9 is a block diagram of a reception apparatus according to further yet another embodiment of the present invention.

Referring to FIG. 9, the reception apparatus 900 includes a demultiplexer 910, one soft HARQ block 920, and an HARQ analysis device 930.

The operations of the demultiplexer 910 and the HARQ analysis device 930 of the reception apparatus 900 are the same as those of the relevant blocks of FIG. 8. Thus, a description of the same operations is omitted.

As described already, the reception apparatus 900 first determines whether received data is initially transmitted data or retransmitted data because an error has been generated in previously transmitted data.

If it is checked that an error has not been generated in the data as a result of demodulation on the initially transmitted data, the received data is directly transferred to a higher layer. If it is checked that an error has been generated in the data, the following process is performed.

If an error has occurred in the initially received data, the received data is transferred to the multiplexer 910 through a relevant CC.

The demultiplexer 910 stores data received through a relevant CC in a block that multiplexes the received data sequentially or in parallel. Furthermore, the demultiplexer 910 transfers the received data to the soft HARQ block 920.

The HARQ analysis device 930 checks the received data of memory allocated to each CC in the soft HARQ block 920 on the basis of information related to an HARQ process for each CC. Here, the soft HARQ block 920 stores the multiplexed data, transferred from the demultiplexer 910, in a predetermined memory region based on each CC.

Accordingly, the HARQ analysis device 930 checks whether an error has occurred in the received data stored in the relevant memory region of the soft HARQ block 920 on the basis of the information related to an HARQ process for each CC. Next, the HARQ analysis device 930 performs an HARQ operation through the HARQ blocks 930 which is logically different based on each CC.

Meanwhile, if retransmitted data is received, the HARQ analysis device 930 combines data, previously stored in the position of memory allocated to each CC in the soft HARQ block 920, and the retransmitted data on the basis of information related to an HARQ process for each CC and attempts to decode the combined data according to a predetermined HARQ algorithm.

Here, if it is checked that an error has not been generated in the data after decoding the data, the HARQ analysis device 930 transfers the received retransmission data to a higher layer and resets the memory region of the relevant CC of the HARQ block 920. In contrast, if it is checked that an error has been generated in the data after decoding the data, the HARQ analysis device 930 informs an ACK/NACK determination unit of the occurrence of the error and transmits an NACK signal so that a transmission apparatus performs retransmission. Accordingly, the HARQ operation is performed again.

As described above, in the present invention, at the time of initial transmission and retransmission, data transmission is adaptively allocated by taking a system environment including a plurality of CCs into consideration, and an HARQ according to retransmission is supported by using HARQ buffers distinguished from one another for each CC or buffers logically distinguished from one another within one HARQ entity. Accordingly, transmission and reception promptness and reliability are guaranteed.

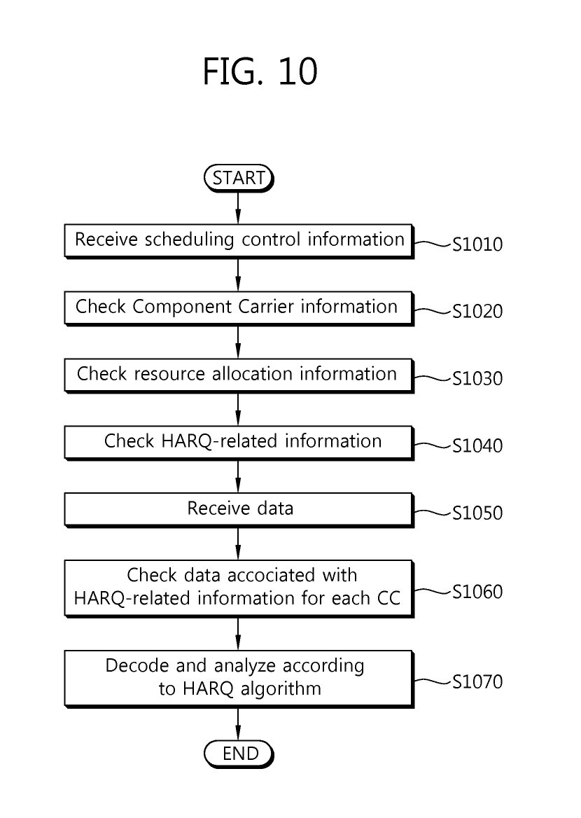

FIG. 10 is a flowchart showing an HARQ operation in which CCs are taken into consideration according to the present invention.

Referring to FIG. 10, the reception apparatus 800, 900 first receives scheduling control information (S1010). Here, a blind decoding method may be used as a method of receiving the scheduling control information, a method of previously recognizing that predetermined resources will be used and receiving relevant information may be used as a method of receiving the scheduling control information, or other methods may be used as a method of receiving the scheduling control information. Here, the blind decoding method is a method of analyzing pieces of information transmitted by a transmission apparatus in the state in which the reception apparatuses 800 and 900 have known only IDs for distinguishing the reception apparatuses 800 and 900 from each other and a method of transmitting information used when the information is transmitted by a scheduler and then selectively receiving pieces of information matched with their own IDs from among the pieces of information.

After receiving the scheduling control information, a CC on which data will be transmitted is checked by checking a CI within the control information (S1020). For example, from FIG. 2, it can be seen that the CC information 330 is CC at the time of new transmission (New Tx) and the CC information 330 is CI=B at the time of retransmission (Re Tx) and thus CCs on which data is transmitted are different from each other at the time of the new transmission and the retransmission. Accordingly, the reception apparatus 800, 900 can identify CCs according to the initial transmission and the retransmission based on the scheduling control information.

After checking information about the CC, information about resources allocated within the relevant CC is checked (S1030). Next, pieces of HARQ-related information including an HPN and an HPS are checked (S1040). Data is received through the relevant CC based on the CC information 330 checked at step S1020 (S1050).

In the present invention, an example in which when the scheduling control information is received (S1010), the steps of checking the CC information (S1020), checking the information about allocated resources (S1030), and checking the pieces of HARQ-related information (S1040) are separated has been described. However, priority of the steps may be differently changed according to system implementations. That is, pieces of information (CC information, resource allocation information, and HARQ-related information) may be sequentially checked by one block and may be simultaneously checked by different blocks corresponding to pieces of information.

The reception apparatus checks data received from memory regions corresponding to respective CCs logically distinguished from one another within one soft buffer in relation to an HARQ on the basis of the HPN and the HPS within the pieces of HARQ-related information or checks data received from buffers distinguished from one another for each CC (S1060).

Next, the checked data is decoded and analyzed according to a predetermined HARQ algorithm (S1070). Here, the HARQ algorithm may include a demodulation algorithm, an MIMO reception method, and a channel estimation method. Furthermore, a transmission apparatus is informed of an ACK/NACK signal based on a result of the performed HARQ. Here, the HARQ-related information may be additionally transmitted to the transmission apparatus.

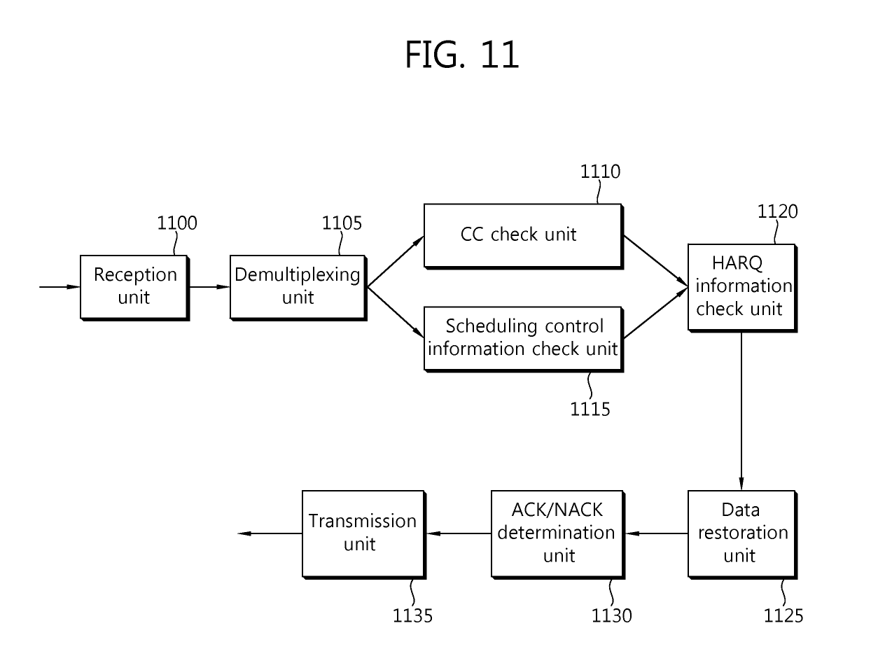

FIG. 11 shows a block diagram of a reception apparatus according to an embodiment of the present invention.

Referring to FIG. 11, a reception unit 1100 receives a transport block through a specific CC and generates scrambled data from the transport block.

A demultiplexing unit 1105 demultiplexes the scrambled data through a plurality of CCs and outputs a data block. Alternatively, the demultiplexing unit 1105 may demultiplex a control channel transmitted through a specific CC and a data channel transmitted though a specific CC. For example, in the physical layer of the reception apparatus, a control channel including scheduling control information may be first received. Alternatively, a data channel including the scheduling control information may be received.

A CC check unit 1110 checks information about a specific CC on which the data block will be transmitted or retransmitted. A scheduling control information check unit 1115 checks scheduling control information related to data. For example, the scheduling control information check unit 1115 may check resource allocation information about a CC on which the data block will be transmitted.

An HARQ information check unit 1120 checks HARQ information related to the data block that will be transmitted or retransmitted. In the present invention, the CC check unit 1110, the scheduling control information check unit 1115, and the HARQ information check unit 1120 are described as being separate blocks, but they may be operated as one hardware block or under the control of software. HARQ information may include at least one of information about an HPS configured based on the number of CCs available to a reception apparatus, an HARQ Process Number (HPN) used for the initial transmission and retransmission of a data block, an RV related to the decoding of the data block, and information about a Carrier Indicator (CI) used for the initial transmission and retransmission of the data block.

A data restoration unit 1125 restores data from the data channel received through the reception unit 1100. For example, the data restoration unit 1125 stores a data block in an HARQ block corresponding to a checked and specific CC, from among a plurality of HARQ blocks corresponding to a plurality of CCs in a one-to-one manner, based on HARQ information and demodulates and decodes the data block. Here, if the data block is retransmitted, the data block is received through a CC different from the specific CC. Accordingly, the data restoration unit 1125 stores the retransmitted data block in an HARQ block corresponding to the different CC.

Here, a demodulation and decoding method according to the restoration of the data may be received based on the scheduling control information or may be restored according to a predetermined rule between a reception apparatus and a transmission apparatus. Furthermore, the data restoration unit 1125 restores the data with consideration taken of data stored in a different HARQ block for each CC or one soft HARQ block on the basis of the checked HARQ information. Next, the data restoration unit 1125 transfers the restored result to the ACK/NACK determination unit 1130 according to a predetermined HARQ scheme.

An ACK/NACK determination unit 1130 generates an ACK or NACK signal by taking the restoration result, transferred from the data restoration unit 1125, into consideration.

A transmission unit 1135 transmits the generated ACK or NACK signal to a transmission apparatus. Here, the ACK or NACK signal may be transmitted through a predetermined physical channel. For example, the ACK or NACK signal may be transmitted through a Physical Hybrid ARQ Indicator CHannel (PHICH).

Furthermore, in the present invention, a downlink data reception apparatus may further include information about a relevant CC with an error along with the ACK/NACK signal for the received data and transmit the information. Furthermore, HARQ-related information according to an HARQ operation may be further included in data with an error and then transmitted. HARQ-related information about the occurrence of the error may be transmitted through a PHICH, a Physical Uplink Shared CHannel (PUSCH), or a Physical Uplink Control CHannel (PUCCH).

Here, the ACK/NACK signal and the HARQ-related information may be transmitted through the same uplink CC as a CC through which the data has been transmitted or may be transmitted through the same uplink CC as a CC through which scheduling control information related to the data has been transmitted. Furthermore, the ACK/NACK signal and the HARQ-related information may be transmitted through an uplink CC selected by a reception apparatus, from among uplink CCs allocated to a reception apparatus that exists when the ACK/NACK signal is generated and transmitted.

As described above, in the present invention, in a situation in which a reception apparatus gets out of the service range of a relevant CC owing to a change in the position of the reception apparatus, if the transmission of data is failed, if a channel state is not changed over time, or in a specific environment in which CCs have different service ranges, retransmission data is transmitted by using a CC different from a CC on which the data is transmitted. Accordingly, the gain of channel state diversity for a predetermined CC and frequency band can be obtained, and performance for an HARQ can be improved

Furthermore, the present invention has an advantage in that it can be operated as a relevant algorithm corresponding to an algorithm for reducing the loss of system resources in an environment in which a gain according to data retransmission by an HARQ algorithm is rarely obtained.

While some exemplary embodiments of the present invention have been described with reference to the accompanying drawings, those skilled in the art may change and modify the present invention in various ways without departing from the essential characteristic of the present invention. Accordingly, the disclosed embodiments should not be construed to limit the technical spirit of the present invention, but should be construed to illustrate the technical spirit of the present invention. The scope of the technical spirit of the present invention is not limited by the embodiments, and the scope of the present invention should be interpreted based on the following appended claims. Accordingly, the present invention should be construed to cover all modifications or variations induced from the meaning and scope of the appended claims and their equivalents.

1. An apparatus for transmitting data in a wireless communication system supporting a plurality of Component Carriers (CCs), the data transmission apparatus comprising:
a plurality of Hybrid Automatic Repeat reQuest (HARQ) blocks corresponding to the plurality of CCs in a one-to-one manner and storing a data block to be transmitted through a specific CC;
a multiplexer multiplexing the data block and outputting multiplexed data;
a scrambler performing scrambling on the multiplexed data and outputting scrambled data;
one or more transmission units transmitting the scrambled data through a predetermined CC; and
a scheduler controlling the plurality of HARQ blocks, the multiplexer, and the transmission units by indicating HARQ control information based on initial transmission and retransmission of the data block.

2. The data transmission apparatus of claim 1, wherein:
the plurality of HARQ blocks performs retransmission of a data block corresponding to Non-ACKnowledgement (NACK), from among a plurality of data blocks stored therein, and
the retransmission of the data block corresponding to the NACK is performed through a second HARQ block which is different from a first HARQ block corresponding to a first CC used in initial transmission of the data block corresponding to the NACK.

3. The data transmission apparatus of claim 1, wherein the multiplexer outputs a data block through a first CC to a first HARQ block, from among the plurality of HARQ blocks or, if the data block is for retransmission, outputs the data block through a second CC to the first HARQ block, the a second CC is different from the first CC based on the HARQ control information indicated by the scheduler.

4. The data transmission apparatus of claim 1, wherein the HARQ control information comprises at least one of information about an HARQ Process Set (HPS) configured based on a number of CCs available to a reception apparatus, an HARQ Process Number (HPN) used for the initial transmission and retransmission of the data block, a Redundancy Version (RV) related to decoding of the data block, and information about a Carrier Indicator (CI) used for the initial transmission and retransmission of the data block.

5. The data transmission apparatus of claim 4, wherein the information about a CI is set with a different CI value if different CCs are allocated to an HPN and an HPS identical with each other.

6. A method of transmitting data in a wireless communication system supporting a plurality of Component Carriers (CCs), the data transmission method comprising the steps of:
storing a data block to be transmitted through a specific CC in a plurality of HARQ blocks corresponding to the plurality of CCs in a one-to-one manner;
multiplexing the data block to output multiplexed data;
performing scrambling on the multiplexed data to output scrambled data; and
transmitting, through a predetermined CC, one or more transport blocks through which the scrambled data is transmitted.

7. The data transmission method of claim 6, wherein the step of transmitting one or more transport blocks comprises performing retransmission of a data block corresponding to NACK, from among the one or more transport blocks, wherein the retransmission of the data block corresponding to the NACK is performed through a second HARQ block different from a first HARQ block corresponding to a first CC used in initial transmission of the data block corresponding to the NACK.

8. The data transmission method of claim 6, wherein the step of multiplexing the data block comprises multiplexing a data block outputted to a first HARQ block, from among the plurality of HARQ blocks, and outputting the multiplexed data through a first CC or, if the data block is for retransmission, multiplexing the data block outputted to the first HARQ block and outputting the multiplexed data through a second CC different from the first CC based on HARQ control information.

9. The data transmission method of claim 8, wherein the HARQ control information comprises at least one of information about an HARQ Process Set (HPS) configured based on a number of CCs available to a reception apparatus, an HARQ Process Number (HPN) used for initial transmission and retransmission of the data block, a Redundancy Version (RV) related to decoding of the data block, and information about a Carrier Indicator (CI) used for the initial transmission and retransmission of the data block.

10. The data transmission method of claim 9, wherein the information about a CI is set with a different CI value if an HPN and an HPS identical with each other are allocated to different CCs.

11. An apparatus for receiving data in a wireless communication system supporting a plurality of Component Carriers (CCs), the data reception apparatus comprising:
a CC check unit checking a specific CC based on information about the CCs;
a reception unit receiving scrambled data through the checked specific CC;
a demultiplexer demultiplexing the scrambled data to output a data block;
an HARQ information check unit checking HARQ control information related to transmission or retransmission of the data block;
a data restoration unit storing the data block in an HARQ block corresponding to the checked specific CC, from among a plurality of HARQ blocks corresponding to the plurality of CCs in a one-to-one manner, based on the HARQ control information and demodulating and decoding the data block;
an ACK/NACK determination unit generating an ACK/NACK signal based on a result of the demodulation and decoding of the data block; and
a transmission unit transmitting the ACK/NACK signal.

12. The data reception apparatus of claim 11, wherein if the data block is retransmitted, the reception unit receives the retransmitted data block through a CC different from the specific CC.

13. The data reception apparatus of claim 12, wherein the data restoration unit stores the retransmitted data block in an HARQ block corresponding to the different CC.

14. The data reception apparatus of claim 11, wherein the HARQ control information comprises at least one of information about an HARQ Process Set (HPS) configured based on a number of CCs available to a reception apparatus, an HARQ Process Number (HPN) used for initial transmission and retransmission of the data block, a Redundancy Version (RV) related to the decoding of the data block, and information about a Carrier Indicator (CI) used for the initial transmission and retransmission of the data block.

15. The data reception apparatus of claim 14, wherein the information about a CI is set with a different CI value if an HPN and an HPS identical with each other are allocated to different CCs.

16. A method of receiving data in a wireless communication system supporting a plurality of Component Carriers (CCs), the method comprising the steps of:
checking a specific CC based on information about the CCs;
receiving scrambled data through the checked specific CC;
demultiplexing the scrambled data to output a data block;
checking HARQ control information related to transmission or retransmission of the data block;
storing the data block in an HARQ block corresponding to the checked specific CC, from among a plurality of HARQ blocks corresponding to the plurality of CCs in a one-to-one manner, based on the HARQ control information;
demodulating and decoding the data block;
generating an ACK/NACK signal according to a result of the demodulation and decoding of the data block; and
transmitting the ACK/NACK signal.

17. The data reception method of claim 16, wherein the data block is retransmitted through a CC different from the specific CC.

18. The data reception method of claim 17, wherein the retransmitted data block is stored in an HARQ block corresponding to the different CC.

19. The data reception method of claim 16, wherein the HARQ control information comprises at least one of information about an HARQ Process Set (HPS) configured based on a number of CCs available to a reception apparatus, an HARQ Process Number (HPN) used for initial transmission and retransmission of the data block, a Redundancy Version (RV) related to the decoding of the data block, and information about a Carrier Indicator (CI) used for the initial transmission and retransmission of the data block.

20. The data reception method of claim 19, wherein the information about a CI is set with a different CI value if an HPN and an HPS identical with each other are allocated to different CCs.
